(19) United States
(12) Patent Application Publication
(10) Pub. No.: US 2025/0202995 A1
(43) Pub. Date: Jun. 19, 2025

(54) BACK-TO-SOURCE METHOD, APPARATUS, ELECTRONIC DEVICE AND STORAGE MEDIUM

(71) Applicant: Beijing Zitiao Newwork Technology Co, Ltd., Beijing (CN)

(72) Inventors: Gengen LI, Beijing (CN); Hao LI, Beijing (CN); Wangqiu YOU, Beijing (CN)

(21) Appl. No.: 18/961,263

(22) Filed: Nov. 26, 2024

(30) Foreign Application Priority Data
Dec. 14, 2023 (CN) 202311719244.0

(51) Int. Cl. H04L 67/60; H04L 67/141

(52) U.S. Cl. CPC H04L 67/60; H04L 67/141

(57) ABSTRACT

The present disclosure relates to a back-to-source method, an electronic device and a storage medium. The method includes: detecting, in response to a node in a target device set receiving a subscription request, whether there is a back-to-source node in the target device set; determining, in response to there being no back-to-source node in the target device set, a back-to-source node from the node receiving the subscription request in the target device set, and performing a back-to-source operation through the back-to-source node.

### CROSS-REFERENCE TO RELATED APPLICATION

The present application claims priority of Chinese Patent Application No. 202311719244.0, filed on Dec. 14, 2023, and the entire content disclosed by the Chinese patent application is incorporated herein by reference as part of the present application for all purposes under the U.S. law.

### TECHNICAL FIELD

The present disclosure relates to the technical field of data transmission, and in particular to a back-to-source method, apparatus, an electronic device and a storage medium.

### BACKGROUND

With the continuous development of Internet technology, users can conveniently watch videos online or participate in video conferences online through mobile phones and other terminals. When a video goes back to the source, one node is selected as the back-to-source node by means of consistent hashing in the related technologies, and other nodes pull stream from the back-to-source node. However, there may be additional internal cascades in the related technologies, and the additional internal cascades will cause a waste of resource of nodes and result in low back-to-source efficiency.

### SUMMARY

At least one embodiment of the present disclosure provides a back-to-source method, which comprises:
detecting, in response to a node in a target device set receiving a subscription request, whether there is a back-to-source node in the target device set;
determining, in response to there being no back-to-source node in the target device set, a back-to-source node from the node receiving the subscription request in the target device set, and performing a back-to-source operation through the back-to-source node.

At least one embodiment of the present disclosure further provides an electronic device, which comprises:
at least one processor;
at least one memory, configured to store instructions executable by the at least one processor;
wherein the at least one processor is configured to execute the instructions to implement a back-to-source method, comprising:
detecting, in response to a node in a target device set receiving a subscription request, whether there is a back-to-source node in the target device set;
determining, in response to there being no back-to-source node in the target device set, a back-to-source node from the node receiving the subscription request in the target device set, and performing a back-to-source operation through the back-to-source node.

At least one embodiment of the present disclosure further provides a non-transient computer-readable storage medium, comprising computer-executable instructions, wherein the computer-executable instructions, upon being executed by a computer processor, perform a back-to-source method, which comprises:
detecting, in response to a node in a target device set receiving a subscription request, whether there is a back-to-source node in the target device set;
determining, in response to there being no back-to-source node in the target device set, a back-to-source node from the node receiving the subscription request in the target device set, and performing a back-to-source operation through the back-to-source node.

### BRIEF DESCRIPTION OF DRAWINGS

More details, features and advantages of the present disclosure are disclosed in the following description of exemplary embodiments in conjunction with the drawings, in which:

FIG. 1 is a schematic diagram of a scenario provided by the related art;

FIG. 2 is a schematic diagram of a scenario provided by an exemplary embodiment of the present disclosure;

FIG. 3 is a flowchart of a back-to-source method provided by an exemplary embodiment of the present disclosure;

FIG. 4 is a schematic block diagram of functional modules of a back-to-source apparatus provided by an exemplary embodiment of the present disclosure;

FIG. 5 is a structural block diagram of an electronic device provided by an exemplary embodiment of the present disclosure; and

FIG. 6 is a structural block diagram of a computer system provided by an exemplary embodiment of the present disclosure.

### DETAILED DESCRIPTION

The above and other features, advantages, and aspects of each embodiment of the present disclosure may become more apparent by combining drawings and referring to the following specific implementation modes. In the drawings throughout, same or similar drawing reference signs represent same or similar elements. It should be understood that the drawings are schematic, and originals and elements may not necessarily be drawn to scale.

Embodiments of the present disclosure are described in more detail below with reference to the drawings. Although certain embodiments of the present disclosure are shown in the drawings, it should be understood that the present disclosure may be achieved in various forms and should not be construed as being limited to the embodiments described here. On the contrary, these embodiments are provided to understand the present disclosure more clearly and completely. It should be understood that the drawings and the embodiments of the present disclosure are only for exemplary purposes and are not intended to limit the scope of protection of the present disclosure.

It should be understood that various steps recorded in the implementation modes of the method of the present disclosure may be performed according to different orders and/or performed in parallel. In addition, the implementation modes of the method may include additional steps and/or steps omitted or unshown. The scope of the present disclosure is not limited in this aspect.

The term “including” and variations thereof used in this article are open-ended inclusion, namely “including but not limited to”. The term “based on” refers to “at least partially based on”. The term “one embodiment” means “at least one embodiment”; the term “another embodiment” means “at least one other embodiment”; and the term “some embodiments” means “at least some embodiments”. Relevant definitions of other terms may be given in the description hereinafter.

It should be noted that concepts such as “first” and “second” mentioned in the present disclosure are only used to distinguish different apparatuses, modules or units, and are not intended to limit orders or interdependence relationships of functions performed by these apparatuses, modules or units. Modifications of “one” and “more” mentioned in the present disclosure are schematic rather than restrictive, and those skilled in the art should understand that unless otherwise explicitly stated in the context, it should be understood as “one or more”.

The names of messages or information exchanged between multiple apparatuses in the embodiments of the present disclosure are illustrative only and not to limit the scope of the messages or information.

It is to be understood that before using technical solutions disclosed in various embodiments of the present disclosure, a user should be notified of the type, scope of use, use scene and the like of personal information involved in the present disclosure in an appropriate manner according to relevant laws and regulations, and authorization from the user should be acquired.

For example, in response to receiving an active request from a user, prompt information is sent to the user to explicitly remind the user that the requested operation requires acquisition and use of personal information of the user. Therefore, the user can independently choose, according to the prompt information, whether to provide personal information to software or hardware, such as an electronic device, an application program, a server, or a storage medium, etc., for executing operations of the technical solution of the present disclosure.

In an optional but non-limiting embodiment, in response to receiving the active request from the user, the manner in which the prompt information is sent to the user may be, for example, in the form of a pop-up window in which the prompt information may be presented in text. Additionally, the pop-up window may also carry a selection control for the user to select “agree” or “disagree” to determine whether to provide personal information to the electronic device. It is to be understood that the preceding process of notifying the user and obtaining authorization from the user is illustrative only and does not limit the embodiments of the present disclosure, and that other manners complying with relevant laws and regulations may also be applied to the embodiments of the present disclosure.

According to the back-to-source method, apparatus, the electronic device and the storage medium provided by the embodiments of the present disclosure, in the case where a node in a target device set receives a subscription request, whether there is a back-to-source node in the target device set is detected, and in the case where there is no back-to-source node in the target device set, a back-to-source node is determined from the node receiving the subscription request in the target device set, and a back-to-source operation is performed through the back-to-source node. In this way, the back-to-source node can be determined from the nodes that receive the subscription request in the target device set, and the back-to-source operation can be performed through the back-to-source node, so that the problem of a waste of resource caused by unnecessary cascades in the device set can be avoided, and further, the back-to-source efficiency can be improved.

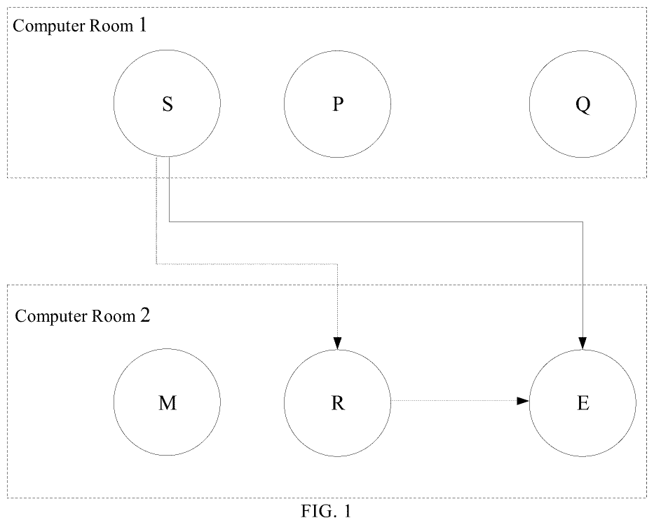

In a multi-person video conference scenario, for example, users belonging to two different regions hold a video conference online, and video stream is transmitted through RTC (Real-Time Communication). As shown in FIG. 1, a user in one region publishes video stream through node S, node P and node Q in device 1 in the device set, or receives video stream released by a user in the other region through node M, node R and node E in device 2 in the device set. The device set can be specifically a computer room. In the embodiment, the device set 1 is specifically described by taking computer room 1 as an example, and the device set 2 is specifically described by taking computer room 2 as an example. The computer room 1 and the computer room 2 can be IDC (Internet Data Center) computer rooms respectively, and the embodiment is not limited to this case. When the devices in the computer room communicate with each other, they belong to a internal network and do not occupy the bandwidth of the public network, which can save the communication cost. However, when the devices in different computer rooms communicate with each other, they need to occupy the bandwidth of the public network, which consumes additional bandwidth cost.

Illustratively, when user A publishes a stream to node S, user B subscribes to the stream through node E. At this time, the server side can use the stream name as the key to perform consistent hashing on all nodes in the computer room 2, and select a node as the back-to-source node, and for example, the back-to-source node is node R. Node E pulls stream data through node R, and node R pulls stream data from node S, as shown by the dashed line in FIG. 1. It should be noted that the back-to-source in the embodiment can be that a node pulls the data stream from the source node; For example, a node sends a back-to-source request to a source node, and when receiving the back-to-source request, the source node sends corresponding data to the node.

However, in the RTC scenario, there is a problem of internal cascade waste when selecting the back-to-source node by means of consistent hashing. In the RTC scenario, for example, there are often video conferences with less than 10 people. In these cases, the case in which there are many nodes for back-to-source in the same IDC computer room is rare. In the same IDC computer room, if there is only one subscription request, then selecting a node as the source node by means of consistent hashing will produce unnecessary additional cascades, and additional internal cascades will cause problems such as the increase of the utilization rate of node CPU (Central Processing Unit).

For example, in the case of consistent hashing algorithm, a back-to-source node R (which is likely to be different from the subscribing node) will be selected first in the IDC computer room, and the subscribing node E performs back-to-source to the back-to-source node R first, and then the back-to-source node R performs back-to-source to the source node S. In this case, the cascade between node E and node R is unnecessary, which will lead to a waste of resource of node R. Therefore, in the case where only one node in the same IDC computer room has a subscription, node E can directly performs back-to-source to the source node S, which can reduce unnecessary cascades in the computer room, as shown by the solid line in FIG. 1.

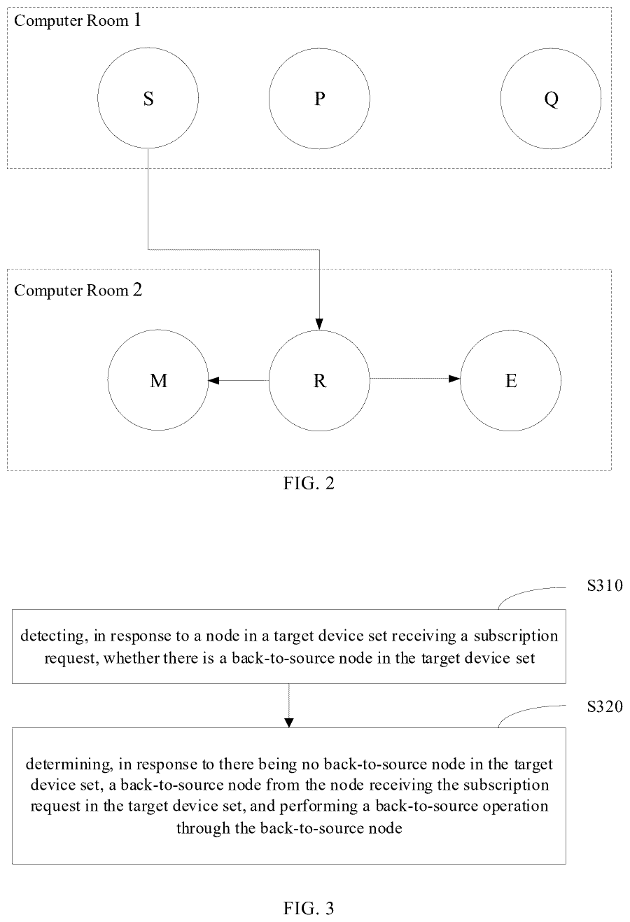

In the embodiment provided by the present disclosure, as shown in FIG. 2, node S is located in the computer room 1, and a user is publishing a video stream through node S. Node R is located in the computer room 2. If node R receives a user's subscription request for the video stream released by node S, it can be firstly detected whether there is a back-to-source node in the nodes in the computer room 2; if there is a back-to-source node, node R can perform back-to-source to node S through the back-to-source node. In an embodiment, the back-to-source node can also be node R itself, and in this case, node R can directly perform back-to-source to node S.

It should be noted that if node R currently receiving the subscription request and the source node S releasing the video stream are located in the same computer room, the communication between node R and node S belongs to an internal network, and the communication between the nodes in the internal network will not consume the bandwidth of the public network; and in this case, node R can perform back-to-source to node S.

As shown in FIG. 2, if the nodes receiving the subscription request in the computer room 2 at this time include other nodes besides node S, such as node M and node E, then node S, node M and node E all need to perform back-to-source to the source node S; and then it is necessary to determine a back-to-source node from the nodes currently receiving the subscription request in the computer room 2, and back-to-source is performed to node S through the back-to-source node.

In the embodiment, because the communication between computer rooms occupies the bandwidth of the public network, if various nodes in the same computer room perform back-to-source to the source node in another computer room respectively, additional bandwidth resources will be consumed. Therefore, the only back-to-source node can be determined from the nodes currently receiving the subscription request, and the back-to-source operation is performed through this back-to-source node, and then other nodes communicate with this back-to-source node to obtain the video stream obtained through the back-to-source operation.

Illustratively, a back-to-source node can be determined from node S, node M and node E that currently receive the subscription request, for example, it can be node R. Then node R located in computer room 2 will establish communication connection with node S located in computer room 1, and the video stream released by the source node S is transmitted to the back-to-source node R, and node E and node M obtain the video stream from the back-to-source node R respectively. In this way, the back-to-source node obtains the video stream released by the source node through the public network, and the back-to-source node transmits the obtained video stream to other nodes in the computer room respectively, which can reduce the waste of resource to a great extent. In addition, in the embodiment, the back-to-source node is determined from the nodes that currently receive the subscription request, which can avoid the case of additional internal cascades generated by taking a node that has not received the subscription request as the back-to-source node.

In the embodiment, a back-to-source node is determined from node S, node M and node E that currently receive the subscription request; for example, it can be determined according to the request time points of the subscription request corresponding to various nodes; for example, the node that receives the subscription request the earliest is taken as the back-to-source node. In an embodiment, the node with the lowest load can also be taken as the source node according to the current load conditions of various nodes.

In the embodiment, a node that currently receives the subscription request can also be set as the back-to-source node through a distributed lock. When other nodes in the same computer room subsequently receive the subscription request, they can perform back-to-source through the back-to-source node, so as to pull the video stream.

Based on the above embodiment, in the embodiments provided by the present disclosure, back-to-source can be implemented based on periodic reporting of a media engine and the distributed lock. The media engine can periodically report which nodes in a certain IDC computer room have back-to-source connections to the current source stream, and a scheduling component can judge, when planning a back-to-source path, whether there is a node connected to the source node in the current IDC room according to the report information; and if there is, an optimal node will be selected as a unified back-to-source node; and is there is no node connected to the source node in the report information, the currently subscribed node is set as the back-to-source node through the distributed lock, and steam can be pulled from the back-to-source node for subsequent subscription requests of other nodes in the IDC computer room.

In the embodiment provided by the present disclosure, for example, when a multi-person conference is held, nodes belonging to different IDC computer rooms, during back-to-source, periodically report information of the nodes that need back-to-source, so that a node list reported by the current media can be obtained, and the node list can include information of the nodes that currently receive the subscription request and information of the nodes that is performing back-to-source. If the node list is empty, it can be judged whether a back-to-source node is uniformly set in Redis. If a back-to-source node has been set, the back-to-source operation can be performed through the back-to-source node. If the back-to-source node is not set, a back-to-source node can be determined from the nodes that need back-to-source.

In the embodiment, if the node list is not empty, for example, the node list only includes one node, then this node can be taken as the back-to-source node. If the node list includes two or more nodes, it is necessary to determine the back-to-source node from the multiple nodes. For example, the node with the lowest load can be taken as the back-to-source node according to the current load conditions of the multiple nodes.

In the embodiment provided by the present disclosure, as shown in FIG. 2, if there are multiple subscriptions in the same IDC, they can be merged into the same subscription node for back-to-source, so as to save bandwidth resources. For example, currently, node M, node R and node E all receive the subscription request to the source node S. Based on the method in the above embodiment, a back-to-source node can be determined from these nodes; that is, node M, node R and node E all perform back-to-source through the determined back-to-source node R, the back-to-source node R pulls the data stream from the source node S, and then node M and node E pull the data stream from the back-to-source node R, so as to achieve the goal of merging node M, node R and node E into the same subscribed node for back-to-source. In addition, in the case where only one node in the same IDC receives the subscription request, this node can be directly taken as the back-to-source node for back-to-source.

Based on the above embodiments, an embodiment of the present disclosure also provides a back-to-source method, as shown in FIG. 3, which can include the following steps:

Step S310: detecting, in response to a node in a target device set receiving a subscription request, whether there is a back-to-source node in the target device set.

Step S320: determining, in response to there being no back-to-source node in the target device set, a back-to-source node from the node receiving the subscription request in the target device set, and performing a back-to-source operation through the back-to-source node.

In the embodiment provided by the present disclosure, for example, in a video conference scenario between multiple persons, different users perform back-to-source through corresponding nodes respectively, so as to obtain the video stream released by the source node. Among different users, some users may be in the same place, and corresponding nodes thereof are located in the same device set; while some users are located in different places, such as in different cities, and corresponding nodes thereof may not be located in the same device set. The device set can be a computer room in the above embodiment.

If the node receiving the subscription request and the source node releasing the video stream are located in the same device set, for example, both are located in the target device set, then the communication connection between the node receiving the subscription request and the source node belongs to an internal connection, which will not occupy the bandwidth of the public network, and the node receiving the subscription request can be directly connected to the source node. For example, if both the source node and the target node receiving the subscription request are located in the target device set, the target node can directly perform back-to-source through the source node, so as to establish communication connection between the target node and the source node, and the target node can directly obtain the video stream released by the source node. However, if the target node receiving the subscription request and the source node are not located in the same device set, that is, the source node is not located in the target device set, then a back-to-source node can be determined from the nodes receiving the subscription request, and the back-to-source operation can be performed through the back-to-source node.

In the embodiment, in the case where nodes in the target device set receive the subscription request, it can be detected whether there is a back-to-source node in the target device set. The subscription request can be, for example, a request that needs to obtain the video stream released by the source node, or the like.

If there is no back-to-source node in the target device set, a back-to-source node can be determined from the nodes that have received the subscription request in the target device set, and a back-to-source operation can be performed through the back-to-source node. In this way, it can avoid the waste of resource caused by unnecessary cascade, generated by taking a node that has not received the subscription request as the back-to-source node, in the target device set. By determining the back-to-source node from the nodes that receive the subscription request in the target device set, and performing a back-to-source operation through the back-to-source node, the back-to-source efficiency can be improved.

If there is a back-to-source node in the target device set, the back-to-source operation can be performed through the back-to-source node. Otherwise, the back-to-source node needs to be determined. Therefore, in the process of determining a back-to-source node from the node receiving the subscription request in the target device set, in the case where the node receiving the subscription request in the target device set includes one node, the one node that receives the subscription request can be taken as the back-to-source node. In the embodiment, because only one node in the target device set currently receives the subscription request, the node can be directly taken as the back-to-source node for back-to-source, and it is not necessary to wait to determine the back-to-source node from the multiple nodes until there are multiple nodes that receive the subscription request in the target device set, thereby improving the back-to-source efficiency.

In the embodiment provided by the present disclosure, in the process of determining a back-to-source node from the node receiving the subscription request in the target device set, in the case where the node receiving the subscription request in the target device set includes a plurality of nodes, the subscription time points when the plurality of nodes respectively receive the subscription request can be obtained, and the back-to-source node can be determined from the plurality of nodes based on the above subscription time points. In this way, the node that receives the subscription request the earliest can be taken as the back-to-source node in priority, which is convenient for obtaining the data stream released by the source node, such as video stream, through the back-to-source node in time.

In the embodiment, under the condition that the back-to-source node is determined, the back-to-source node can be set through a distributed lock to ensure the uniqueness of the back-to-source node, and the unique back-to-source node can be determined by means of lock grabbing from the plurality of nodes that receive the subscription request. It should be noted that in the embodiment, the same source node is taken as an example for illustration, and in the case where there are multiple different source nodes, processing can be carried out according to the subscription requests of the corresponding source nodes, which is not repeated here.

Based on the above embodiment, in another embodiment provided by the present disclosure, if a plurality of nodes in the target device set respectively receive the subscription request at the same time, or a plurality of nodes in the target device set respectively receive the subscription request within a certain period of time, a back-to-source node can be determined from the plurality of nodes. For example, besides determining the back-to-source node according to the time point when the subscription request is received, the node with the lowest load can be selected as the back-to-source node according to the current load conditions of various nodes, so that the back-to-source efficiency can be improved and problems caused by overload of nodes can be avoided as much as possible.

Based on the above embodiment, in another embodiment provided by the present disclosure, if there is a back-to-source node in the target device set, it can be judged whether the back-to-source node currently receives a subscription request, that is, whether the back-to-source node is performing back-to-source or is about to perform back-to-source. If the back-to-source node does not receive a back-to-source request, it means that the back-to-source node is currently in an idle state. At this time, in order to avoid unnecessary cascades in the target device set, the back-to-source node can be cancelled and a back-to-source node can be determined from the nodes that currently receive the subscription request.

In an embodiment, the media engine will regularly or periodically report node information of the back-to-source node, the node information can be presented in the form of a node list, and the node list can include information of nodes in the back-to-source state. In the case where the node list includes at least two nodes, the current load information of each node in the node list can be obtained, and based on the load information, a back-to-source node can be determined from the node list. For example, the node with the lowest current load can be taken as the back-to-source node. Illustratively, the load information can be the utilization rate of the CPU, etc. Therefore, the back-to-source efficiency of the determined back-to-source node can be higher, thereby avoiding the situation where using a node with an excessive load as a back-to-source node may lead to low back-to-source efficiency.

In the embodiment, in the case where the node list is empty, a preset back-to-source node can be obtained, and the back-to-source operation can be performed through the back-to-source node. If there is one node in the node list, this node can be directly taken as the back-to-source node for back-to-source.

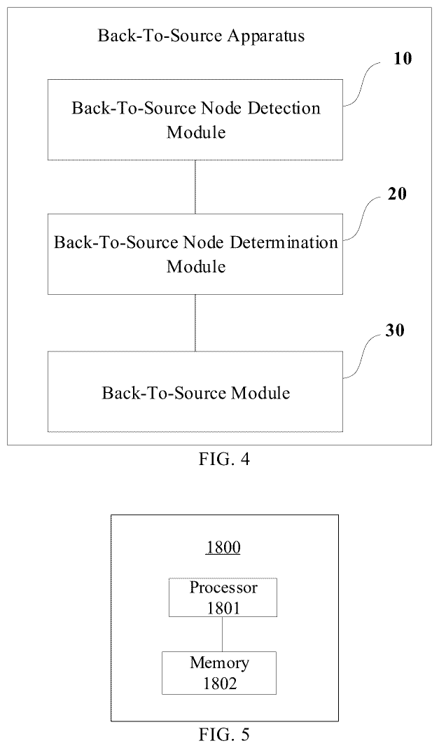

In the case where the functional modules are divided using the corresponding functions, an embodiment of the present disclosure provides a back-to-source apparatus, which can be a server, a terminal or a chip applied to a server. FIG. 4 is a schematic block diagram of functional modules of a back-to-source apparatus provided by an exemplary embodiment of the present disclosure. As shown in FIG. 4, the back-to-source apparatus includes:
a back-to-source node detection module 10, configured to detect, in a case where a node in a target device set receives a subscription request, whether there is a back-to-source node in the target device set;
a back-to-source node determination module 20, configured to determine, in a case where there is no back-to-source node in the target device set, a back-to-source node from the node receiving the subscription request in the target device set;
a back-to-source module 30, configured to perform a back-to-source operation through the back-to-source node.

In another embodiment provided by the present disclosure, the back-to-source node determination module is specifically configured to:
take, in a case where the node receiving the subscription request in the target device set includes one node, the one node that receives the subscription request as the back-to-source node.

In another embodiment provided by the present disclosure, the back-to-source node determination module is further specifically configured to:
obtain, in a case where the node receiving the subscription request in the target device set includes a plurality of nodes, subscription time points when the plurality of nodes respectively receive the subscription request;
determining, based on the subscription time points, the back-to-source node from the plurality of nodes.

In another embodiment provided by the present disclosure, the apparatus further includes:
a back-to-source node setting module, configured to set the back-to-source node through a distributed lock.

In another embodiment provided by the present disclosure, the apparatus further includes:
a connection establishment module, configured to establish, in a case where both a source node and a target node receiving the subscription request are located in the target device set, a back-to-source connection between the target node and the source node.

In another embodiment provided by the present disclosure, the back-to-source node determination module is further specifically configured to:
determine, in a case where a target node receiving the subscription request is not located in the target device set, a back-to-source node from the node receiving the subscription request in the target device set.

In another embodiment provided by the present disclosure, the back-to-source node determination module is further specifically configured to:
determine, in a case where there is a back-to-source node in the target device set, a back-to-source node from the node receiving the subscription request in the target device set if the back-to-source node does not currently receive the subscription request.

In another embodiment provided by the present disclosure, the apparatus further includes:
a node list obtaining module, configured to obtain a node list, wherein the node list includes information of nodes in a back-to-source state;
a video information obtaining module, configured to obtain target video information in the source video;
a load information obtaining module, configured to obtain, in a case where the node list includes at least two nodes, current load information of each node in the node list,
a node determination module, configured to determine, based on the load information, a back-to-source node from the node list.

In another embodiment provided by the present disclosure, the back-to-source module is further specifically configured to:
obtain, in a case where the node list is empty, a preset back-to-source node, and perform a back-to-source operation through the back-to-source node.

The apparatus part corresponds to the above method, and please refer to the corresponding description of the method embodiments for details, which will not be repeated here.

In the back-to-source apparatus provided by the embodiment of the present disclosure, in the case where a node in a target device set receives a subscription request, whether there is a back-to-source node in the target device set is detected, and in the case where there is no back-to-source node in the target device set, a back-to-source node is determined from the node receiving the subscription request in the target device set, and a back-to-source operation is performed through the back-to-source node. In this way, it can avoid the waste of resource caused by unnecessary cascade, generated by taking a node that has not received the subscription request as the back-to-source node, in the target device set. By determining the back-to-source node from the nodes that receive the subscription request in the target device set, and performing a back-to-source operation through the back-to-source node, the back-to-source efficiency can be improved.

An embodiment of the present disclosure further provides an electronic device, which includes: at least one processor; a memory, configured to store instructions executable by the at least one processor; wherein the at least one processor is configured to execute the instructions to implement the method disclosed in the embodiments of the present disclosure.

FIG. 5 is a schematic structural diagram of an electronic device provided by an exemplary embodiment of the present disclosure. As shown in FIG. 5, the electronic device 1800 includes at least one processor 1801 and a memory 1802 coupled to the processor 1801, and the processor 1801 can execute the corresponding steps in the above method disclosed in the embodiments of the present disclosure.

The above processor 1801 can also be called a central processing unit (CPU), which can be an integrated circuit chip with signal processing capability. Each step in the above method disclosed in the embodiments of the present disclosure can be completed by instructions in the form of software or a hardware integrated logic circuit in the processor 1801. The above processor 1801 can be a general-purpose processor, a digital signal processor (DSP), an application specific integrated circuit (ASIC), a field-programmable gate array (FPGA) or another programmable logic device, a discrete gate or a transistor logic device, and discrete hardware component. The general-purpose processor can be a microprocessor, or the processor may be any conventional processor or the like. The operations of the method disclosed in the embodiments of the present disclosure can be directly performed and completed by a hardware decoding processor, or can be performed and completed by using a combination of hardware and software modules in the decoding processor. The software module can be located on the memory 1802, such as a random access memory, a flash memory, a read-only memory, a programmable read-only memory, an electrically erasable programmable memory, a register, or other mature storage medium in this field. The processor 180 reads information in the memory 1802 and completes the steps of the above method in combination with hardware thereof.

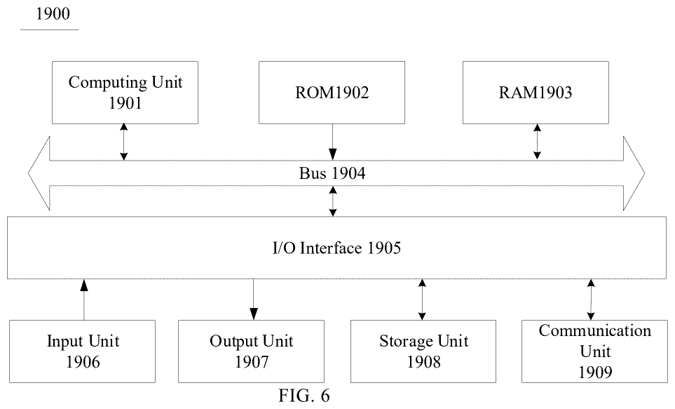

In addition, in the case where various operations/processing according to the present disclosure are implemented by software and/or firmware, programs constituting the software can be installed from a storage medium or a network to a computer system with a dedicated hardware structure, such as the computer system 1900 shown in FIG. 6. When the computer system is installed with various programs, the computer system can perform various functions, including the functions described above, etc. FIG. 6 is a structural block diagram of a computer system provided by an exemplary embodiment of the present disclosure.

The computer system 1900 is intended to represent various forms of digital electronic computer devices, such as a laptop computer, a desktop computer, a workstation, a personal digital assistant, a server, a blade server, a mainframe computer, and other suitable computers. The computer system 1900 can further represent various forms of mobile apparatuses, such as a personal digital assistant, a cellular phone, a smart phone, a wearable device, and other similar computing apparatuses. The components shown in the present disclosure, their connections and relationships, and their functions are merely examples, and are not intended to limit the implementation of the present disclosure described and/or claimed herein.

As shown in FIG. 6, the computer system 1900 includes a computing unit 1901, and the computing unit 1901 is configured to execute various appropriate actions and processing according to a computer program stored in a read-only memory (ROM) 1902 or loaded from a storage unit 1908 to a random access memory (RAM) 1903. In the RAM 1903, various programs and data required for the computer system 1900 can also be stored. The computing unit 1901, the ROM 1902 and the RAM 1903 can be connected with each other through a bus 1904. An input/output (I/O) interface 1905 is also connected to the bus 1904.

A plurality of components in the computer system 1900 are connected to the I/O interface 1905, including: an input unit 1906, an output unit 1907, the storage unit 1908, and a communication unit 1909. The input unit 1906 can be any type of device capable of entering information to the computer system 1900. The input unit 1906 can receive entered digit or character information, and generate a key signal input related to user settings and/or function control of the computer system 1900. The output unit 1907 can be any type of device capable of presenting information, and can include, but is not limited to, a display, a speaker, a video/audio output terminal, a vibrator, and/or a printer. The storage unit 1908 can include, but is not limited to, a magnetic disk or an optical disk. The communication unit 1909 allows the computer system 1900 to exchange information/data with other devices through a network such as the Internet, and can include, but is not limited to, a modem, a network interface card, an infrared communication device, a wireless communication transceiver, and/or a chipset, such as a Bluetooth device, a WiFi device, a WiMax device, a cellular communication device and/or the like.

The computing unit 1901 can be various types of general and/or dedicated processing components with processing and computing capabilities. Some examples of the computing unit 1901 include but not limited to a central processing unit (CPU), a graphics processing unit (GPU), various dedicated artificial intelligence (AI) computing chips, various computing units running a machine learning model algorithm, a digital signal processor (DSP), and any appropriate processor, controller, microcontroller, etc. The computing unit 1901 executes various methods and processing as described above. For example, in some embodiments, the above method disclosed in the embodiments of the present disclosure can be implemented as a computer software program, which is physically contained on a machine-readable medium, such as the storage unit 1908. In some embodiments, a part or all of the computer program can be loaded and/or installed on the electronic device via the ROM 1902 and/or the communication unit 1909. In some embodiments, the computing unit 1901 can be configured to perform the above method disclosed in the embodiments of the present disclosure in any other suitable manner (e.g., by means of firmware).

An embodiment of the present disclosure further provides a computer-readable storage medium, wherein when instructions on the computer-readable storage medium are executed by a processor of an electronic device, the electronic device is enabled to perform the above method disclosed in the embodiments of the present disclosure.

In the embodiment of the present disclosure, the computer-readable storage medium can be a tangible medium, which may contain or store a program for use by an instruction execution system, apparatus, or device or for use in combination with the instruction execution system, apparatus, or device. The computer-readable storage medium can include, but is not limited to an electrical, magnetic, optical, electromagnetic, infrared, or semiconductor system, apparatus, or device, or any suitable combination of the foregoing. More specifically, the computer-readable storage medium can include an electrical connection having one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the foregoing.

The above-described computer-readable medium may be included in the above-described electronic device; or may also exist alone without being assembled into the electronic device.

An embodiment of the present disclosure further provides a computer program product, including a computer program, wherein the computer program, when executed by a processor, implement the above method disclosed in the embodiment of the present disclosure.

The computer program code for executing the operation of the present disclosure may be written in one or more programming languages or combinations thereof, the above programming language includes but is not limited to object-oriented programming languages such as Java, Smalltalk, and C++, and also includes conventional procedural programming languages such as a “C” language or a similar programming language. The program code may be completely executed on the user's computer, partially executed on the user's computer, executed as a standalone software package, partially executed on the user's computer and partially executed on a remote computer, or completely executed on the remote computer or server. In the case involving the remote computer, the remote computer may be connected to the user's computer by any types of networks, including LAN or WAN, or may be connected to an external computer (such as connected by using an internet service provider through the Internet).

The flow diagrams and the block diagrams in the drawings show possibly achieved system architectures, functions, and operations of systems, methods, and computer program products according to various embodiments of the present disclosure. At this point, each box in the flow diagram or the block diagram may represent a module, a program segment, or a part of a code, the module, the program segment, or a part of the code contains one or more executable instructions for achieving the specified logical functions. It should also be noted that in some alternative implementations, the function indicated in the box may also occur in a different order from those indicated in the drawings. For example, two consecutively represented boxes may actually be executed basically in parallel, and sometimes it may also be executed in an opposite order, this depends on the function involved. It should also be noted that each box in the block diagram and/or the flow diagram, as well as combinations of the boxes in the block diagram and/or the flow diagram, may be achieved by using a dedicated hardware-based system that performs the specified function or operation, or may be achieved by using combinations of dedicated hardware and computer instructions.

The involved units described in the embodiments of the present disclosure may be achieved by a mode of software, or may be achieved by a mode of hardware. Herein, the name of the unit does not constitute a limitation for the unit itself in some cases.

The functions described above in this article may be at least partially executed by one or more hardware logic components. For example, non-limiting exemplary types of the hardware logic component that may be used include: a field programmable gate array (FPGA), an application specific integrated circuit (ASIC), an application specific standard product (ASSP), a system on chip (SOC), a complex programmable logic device (CPLD) and the like.

The above description is only an explanation of some embodiments of the present disclosure and the applied technical principles. Those skilled in the art should understand that the scope of disclosure involved in the present disclosure is not limited to the technical solutions formed by the specific combination of the above technical features, and at the same time, should also cover other technical solutions formed by arbitrarily combining the above-described technical features or equivalent features without departing from the above disclosed concept. For example, the above-described features and the technical features disclosed in the present disclosure (but not limited thereto) having similar functions are replaced with each other to form a technical solution.

Although some specific embodiments of the present disclosure have been described in detail by way of examples, those skilled in the art should understand that the above examples are only for the purpose of illustration but not for limiting the scope of the present disclosure. It should be understood by those skilled in the art that modifications to the above-described embodiments maybe made without departing from the scope and spirit of the present disclosure. The scope of the present disclosure is defined by the appended claims.

1. A back-to-source method, comprising:
detecting, in response to a node in a target device set receiving a subscription request, whether there is a back-to-source node in the target device set; and
determining, in response to there being no back-to-source node in the target device set, a back-to-source node from the node receiving the subscription request in the target device set, and performing a back-to-source operation through the back-to-source node.

2. The method according to claim 1, wherein the determining a back-to-source node from the node receiving the subscription request in the target device set comprises:
taking, in response to the node receiving the subscription request in the target device set comprising one node, the one node that receives the subscription request as the back-to-source node.

3. The method according to claim 1, wherein the determining a back-to-source node from the node receiving the subscription request in the target device set comprises:
obtaining, in response to the node receiving the subscription request in the target device set comprising a plurality of nodes, subscription time points when the plurality of nodes respectively receive the subscription request; and
determining, based on the subscription time points, the back-to-source node from the plurality of nodes.

4. The method according to claim 2, further comprising:
setting the back-to-source node through a distributed lock.

5. The method according to claim 1, further comprising:
establishing, in response to both a source node and a target node receiving the subscription request being located in the target device set, a back-to-source connection between the target node and the source node.

6. The method according to claim 1, further comprising:
performing, in response to a target node receiving the subscription request being not located in the target device set, the step of determining a back-to-source node from the node receiving the subscription request in the target device set.

7. The method according to claim 1, further comprising:
performing, in response to there being a back-to-source node in the target device set, the step of determining a back-to-source node from the node receiving the subscription request in the target device set if the back-to-source node does not currently receive the subscription request.

8. The method according to claim 1, further comprising:
obtaining a node list, wherein the node list comprises information of nodes in a back-to-source state;
obtaining, in response to the node list comprising at least two nodes, current load information of each node in the node list; and
determining, based on the load information, a back-to-source node from the node list.

9. The method according to claim 8, further comprising:
obtaining, in response to the node list being empty, a preset back-to-source node, and performing a back-to-source operation through the back-to-source node.

10. An electronic device, comprising:
at least one processor;
at least one memory, configured to store instructions executable by the at least one processor;
wherein the at least one processor is configured to execute the instructions to implement a back-to-source method, comprising:
detecting, in response to a node in a target device set receiving a subscription request, whether there is a back-to-source node in the target device set; and
determining, in response to there being no back-to-source node in the target device set, a back-to-source node from the node receiving the subscription request in the target device set, and performing a back-to-source operation through the back-to-source node.

11. The electronic device according to claim 10, wherein the determining a back-to-source node from the node receiving the subscription request in the target device set comprises:
taking, in response to the node receiving the subscription request in the target device set comprising one node, the one node that receives the subscription request as the back-to-source node.

12. The electronic device according to claim 10, wherein the determining a back-to-source node from the node receiving the subscription request in the target device set comprises:
obtaining, in response to the node receiving the subscription request in the target device set comprising a plurality of nodes, subscription time points when the plurality of nodes respectively receive the subscription request; and
determining, based on the subscription time points, the back-to-source node from the plurality of nodes.

13. The electronic device according to claim 11, wherein the method further comprises:
setting the back-to-source node through a distributed lock.

14. The electronic device according to claim 10, wherein the method further comprises:
establishing, in response to both a source node and a target node receiving the subscription request being located in the target device set, a back-to-source connection between the target node and the source node.

15. The electronic device according to claim 10, wherein the method further comprises:
performing, in response to a target node receiving the subscription request being not located in the target device set, the step of determining a back-to-source node from the node receiving the subscription request in the target device set.

16. The electronic device according to claim 10, wherein the method further comprises:
performing, in response to there being a back-to-source node in the target device set, the step of determining a back-to-source node from the node receiving the subscription request in the target device set if the back-to-source node does not currently receive the subscription request.

17. The electronic device according to claim 10, wherein the method further comprises:
obtaining a node list, wherein the node list comprises information of nodes in a back-to-source state;
obtaining, in response to the node list comprising at least two nodes, current load information of each node in the node list; and
determining, based on the load information, a back-to-source node from the node list.

18. The electronic device according to claim 17, wherein the method further comprises:
obtaining, in response to the node list being empty, a preset back-to-source node, and performing a back-to-source operation through the back-to-source node.

19. A non-transient computer-readable storage medium, comprising computer-executable instructions, wherein the computer-executable instructions, upon being executed by a computer processor, perform a back-to-source method, comprising:
detecting, in response to a node in a target device set receiving a subscription request, whether there is a back-to-source node in the target device set; and
determining, in response to there being no back-to-source node in the target device set, a back-to-source node from the node receiving the subscription request in the target device set, and performing a back-to-source operation through the back-to-source node.

20. The non-transient computer-readable storage medium according to claim 19, wherein the determining a back-to-source node from the node receiving the subscription request in the target device set comprises:
taking, in response to the node receiving the subscription request in the target device set comprising one node, the one node that receives the subscription request as the back-to-source node.
